(19) United States
(12) Patent Application Publication
(10) Pub. No.: US 2007/0124886 A1
(43) Pub. Date: Jun. 7, 2007

(54) Combination wiper for vehicle outside mirror and front door window

(76) Inventor: Dung-Bao Tsai, Taoyuan City (TW)

Correspondence Address: TROXELL LAW OFFICE PLLC, SUITE 1404, 5205 LEESBURG PIKE, FALLS CHURCH, VA, 22041, US

(21) Appl. No.: 11/477,608

(22) Filed: Jun. 30, 2006

(30) Foreign Application Priority Data
Dec. 6, 2005 (TW) 094221177

(51) Int. Cl. B60S 1/56; B60S 1/46

(52) U.S. Cl. 15/250.003; 15/250.1; 15/250.01

(57) ABSTRACT

A combination wiper for use in a car is disclosed to include a first wiper for cleaning the lens of one outside mirror of the car, a second wiper for cleaning a predetermined part of one front door window of the car, and a transmission system controllable to move the first wiper and the second wiper back and forth so as to clean the lens of the outside mirror and the predetermined part of the front door window.

### BACKGROUND AND SUMMARY OF THE INVENTION

The present invention relates to wipers for motor vehicle and more particularly, to a combination wiper used in a motor vehicle for wiping off rain, dust, sands, etc. from the outside mirror and the front door window so that the driver can see clearly the image on the outside mirror through the front door window.

A car has two windshield wipers attached to the windshield for wiping off rain, snow, dust, etc. to maintain clarity of vision. However, if the outside mirror is covered with raindrops, dust, sands, etc., the driver cannot see traffic approaching from behind. In this case, the driver shall have to stop the car and then wipe off raindrops, dust, sands, etc. from the outside mirror, or lower the front door window and then wipe off the outside mirror. However, if the front door window is covered with raindrops, dust, sands, etc., the driver still cannot see clearly the reflection of traffic in the outside mirror through the front door window during driving.

The present invention has been accomplished under the circumstances in view. It is the main object of the present invention to provide a combination wiper, which wipes off the outside mirror and the corresponding part of the front door window automatically so that the driver can see clearly the reflection of traffic in the outside mirror through the front door window.

To achieve this and other objects of the present invention, the combination wiper is installed in a car and adapted to clean the lens one outside mirror and one front door window of the car, comprising a first wiper adapted to clean the lens of the outside mirror, the first wiper comprising a handle and a rubber blade fixedly fastened to the handle and attached to the lens of the outside mirror; a second wiper adapted to clean a predetermined part of the front door window, the second wiper comprising a handle and a rubber blade fixedly fastened to the handle and attached to the predetermined part of the front door window; and a transmission system adapted to drive the handle of the first wiper and the handle of the second wiper to move the associating rubber blades alternatively back and forth over the lens of the outside mirror and the predetermined part of the front door window.

### BRIEF DESCRIPTION OF THE DRAWING

FIG. 1 is a perspective view showing a combination wiper installed in a car according to the present invention.

FIG. 2 is an elevational view in an enlarged scale of a part of the combination wiper shown in FIG. 1.

FIG. 3 is an elevational view in an enlarged scale of the other part of the combination wiper shown in FIG. 1.

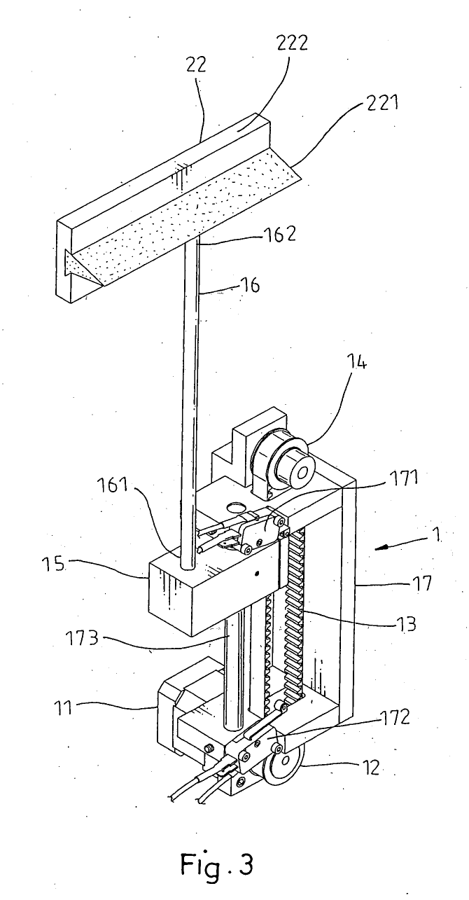

FIG. 4 is a front plain view showing the installation of the connection rod in the outside mirror according to the present invention.

FIG. 5 is an oblique elevation showing the installation of the connection rod in the outside mirror according to the present invention.

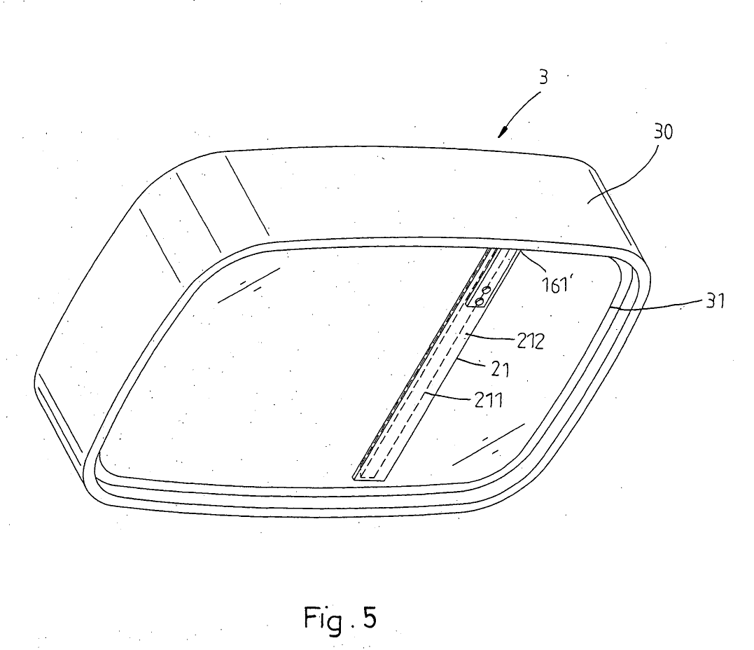

FIG. 6 is an elevational view of a part of the present invention, showing an alternate form of the connection rod.

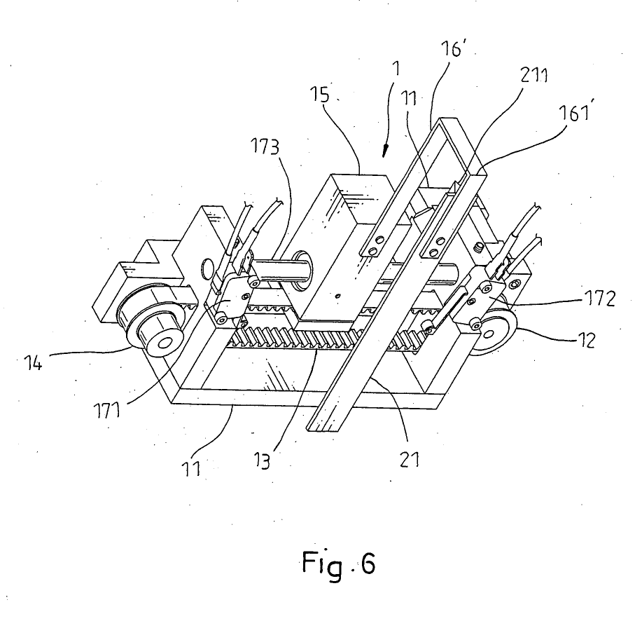

FIG. 7 is a schematic drawing showing installation of a part of another alternate form of the combination wiper in the front door window of the car according to the present invention.

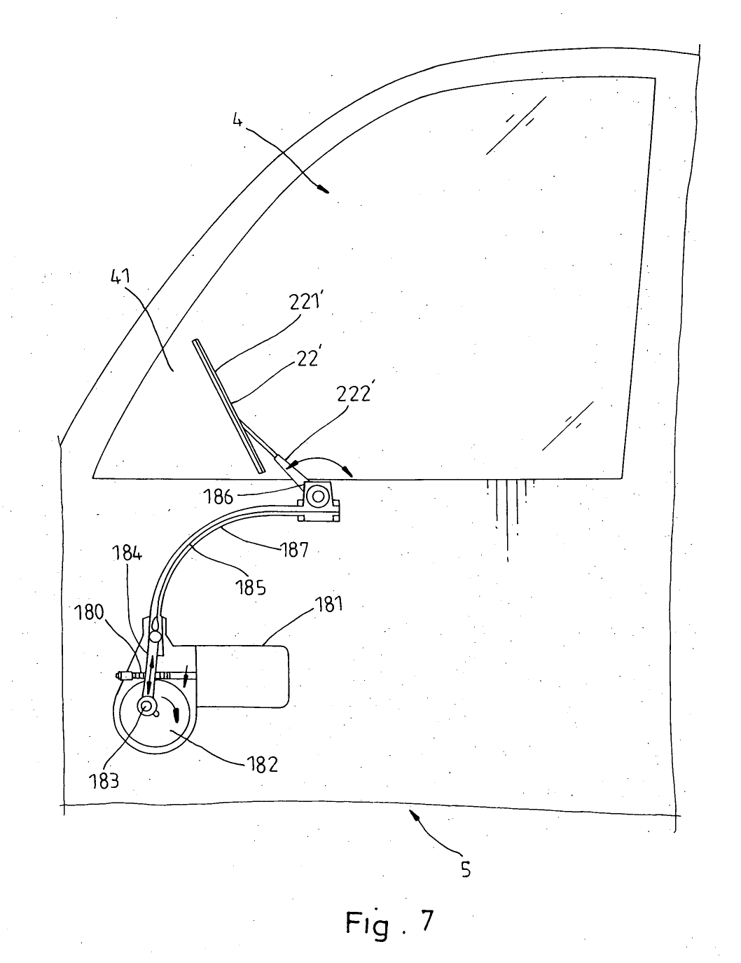

FIG. 8 is a perspective view showing installation of still another alternate form of the combination wiper according to the present invention.

FIG. 9 is an elevational view in an enlarged scale of the combination wiper shown in FIG. 8.

FIG. 10 is a schematic drawing showing installation of still another alternate form of the combination wiper in a car.

FIG. 11 is an elevational view in an enlarged scale of a part of the combination wiper shown in FIG. 10.

FIG. 12 is an elevational view in an enlarged scale of the other part of the combination wiper shown in FIG. 10.

FIG. 13 is an exploded in an enlarged scale of one transmission unit of the combination wiper shown in FIG. 10.

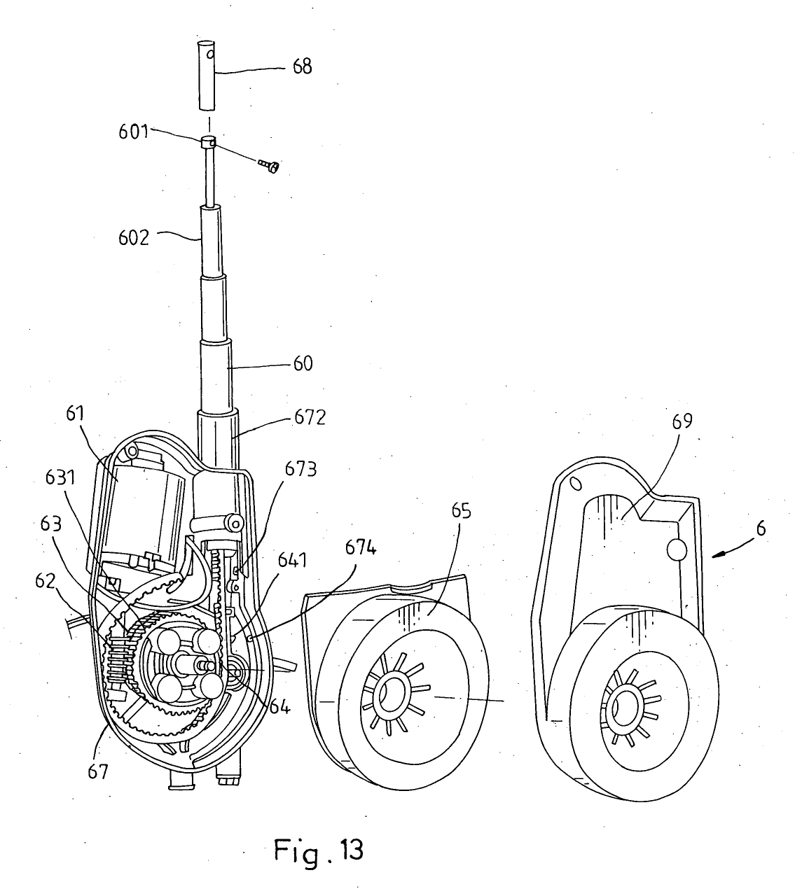

FIG. 14 is a schematic drawing showing installation of still another alternate form of the combination wiper in a car.

FIG. 15 is an elevational view in an enlarged scale of the combination wiper shown in FIG. 14.

FIG. 16 is a schematic drawing showing two spray nozzles connected to a water sprayer for motor vehicle according to the present invention.

FIG. 17 is a schematic drawing showing a dual-end spray nozzle connected to a water sprayer for motor vehicle according to the present invention.

FIG. 18 is an elevational view of an outside mirror, showing the brim forwardly protected from the top side of the housing.

FIG. 19 is a schematic drawing showing still another alternate form of the combination wiper according to the present invention.

FIG. 20 illustrates the application of the water/air spray system in another design of outside mirror.

### DETAILED DESCRIPTION OF THE INVENTION

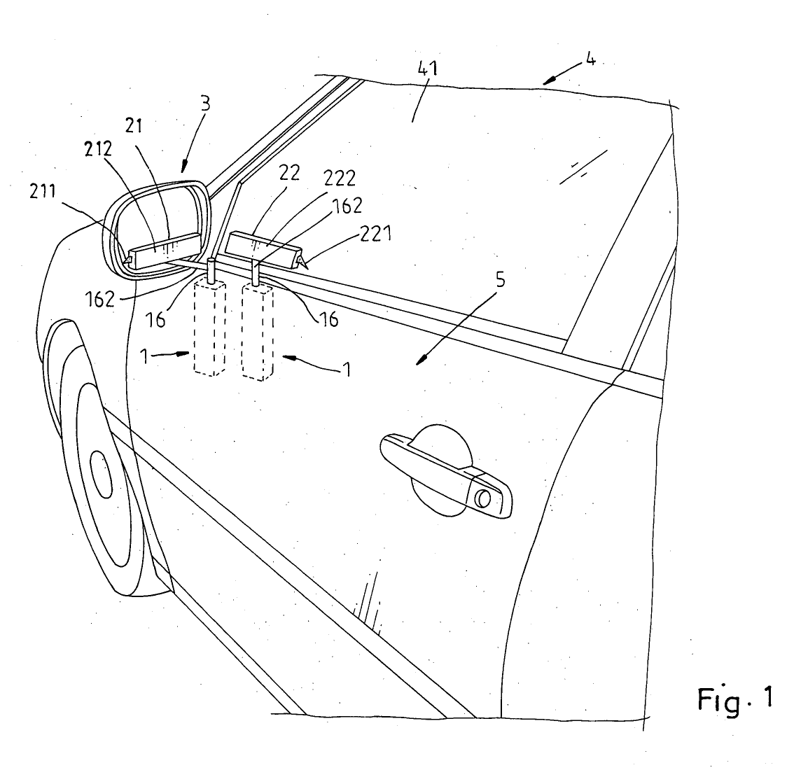

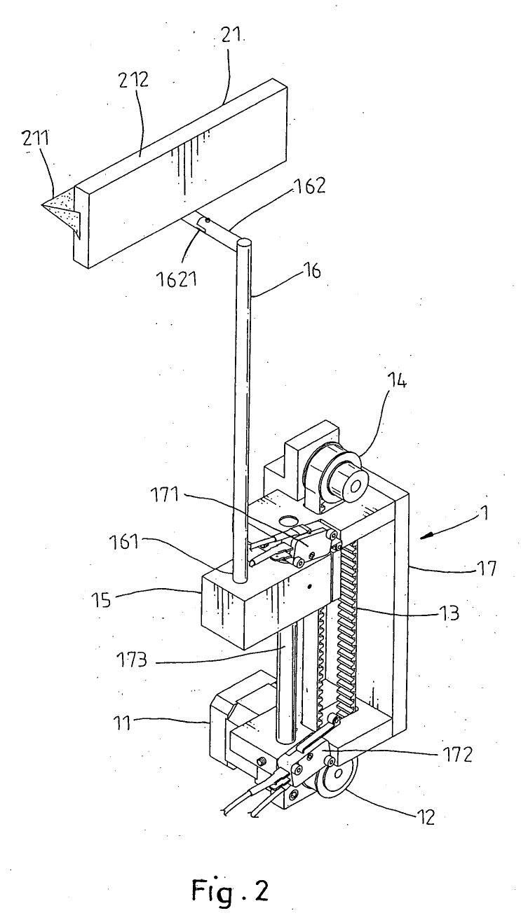

Referring to FIGS. 1 and 2, a combination wiper in accordance with the present invention is shown comprised of two transmission units 1, an outside mirror wiper 21, and a front door window wiper 22. The outside mirror wiper 21 and the front door window wiper 22 are respectively connected to the two transmission units 1 and driven by the transmission units 1 to wipe off the outside mirror 3 and a part 41 of the front door window 4 and to maintain clarity of vision of the part 41 of the front door window 4 and the outside mirror 3 so that the driver can see the reflection of traffic in the outside mirror 3 through the part 41 of the front door window 4.

The two transmission units 1 are fixedly mounted in the front door 5 at a suitable location, each comprised of a motor 11, a transmission wheel 12, a transmission belt 13, a driven wheel 14, a slide 15, a connection rod 16, and a holder frame 17. The connection rod 16 has one end 162 connected to the outside mirror wiper 21 or front door window wiper 22, and the other end 161 connected to the slide 15 (the length and shape of the connection rod 16 may vary with the type of the car). The transmission wheel 12 is connected to and rotatable by the motor 11. The transmission belt 13 is a toothed belt mounted on the transmission wheel 12 and the driven wheel 14. Rotating the motor 11 clockwise and counterclockwise alternatively causes the transmission belt 13 to reciprocate the slide 15. Two sensors, for example, micro switches 171 and 172 are respectively mounted in two opposite sides of the holder frame 17 and respectively electrically connected to a control circuit to control clockwise and counter-clockwise rotation of the motor 11 and to further control the reciprocating distance of the slide 15, and therefore the reciprocation distance of the outside mirror wiper 21 on the outside mirror 3 or the front door window wiper 22 on the front door window 4 is relatively controlled. The holder frame 17 has a guide rod 173 inserted through the slide 15 to guide reciprocation motion of the slide 15. The outside mirror wiper 21 and the front door window wiper 22 each comprise a handle 212 or 222 is connected to the top end 162 of the associating connection rod 16, and a rubber blade 211 or 221 fixedly fastened to the handle 212 or 222. Further, the handle 212 of the outside mirror wiper 21 is connected to the top end 162 of the associating connection rod 16, which has two parts thereof pivotally connected together with a pivot 1621 so that the outside mirror wiper 21 is viable subject to the adjustment of the position of the outside mirror 3.

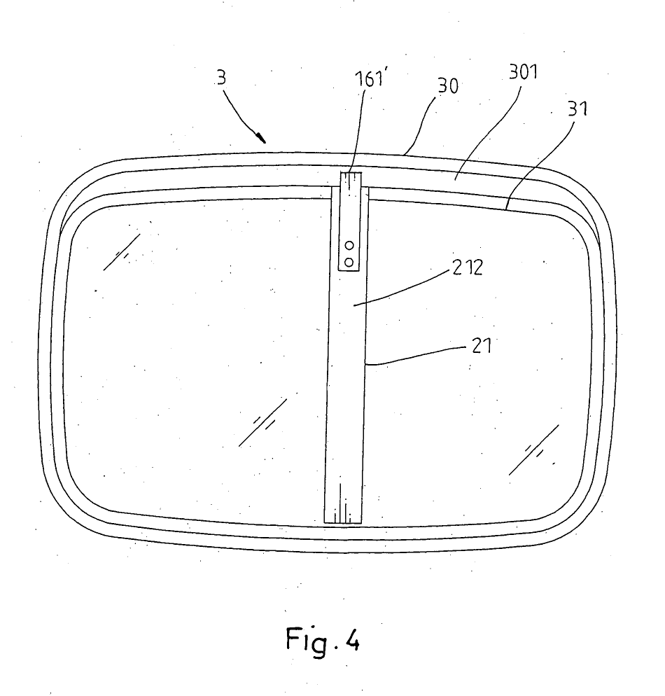

In an alternate form of the present invention as shown in FIGS. 4˜6, one transmission unit 1 is fixedly mounted inside the housing 30 of the outside mirror 3. The outside mirror 3 has an opening 301 defined between the top side of the housing 30 and the top side of the lens 31 for the passing of the top end 161′ of the curved connection rod 16′ of the transmission unit 1 for enabling the top end 161′ to be fastened to the handle 212 of the outside mirror wiper 21.

In another alternate form of the present invention, the transmission unit 1 for driving the front door window wiper 22′ is comprised of a motor 181, a worm 180, a worm gear 182, a crankshaft 183, a link 184, a flexible plastic rack 185, a gearbox 186, and a sleeve 187. The motor 181 is adapted to rotate the worm 180 that is meshed with the worm gear 182. The crankshaft 183 is fixedly connected to the worm gear 182, and rotatable with the worm gear 182 to move the link 184, which is connected to the flexible plastic rack 185. The sleeve 187 surrounds the flexible plastic rack 185. The flexible plastic rack 185 is meshed with a driving gear (not shown) in the gearbox 186. The driving gear of the gearbox 186 is coupled to the wiper arm 222′ of the front door window wiper 22′, and rotatable by the flexible plastic rack 185 to bias the wiper arm 222′, thereby moving the rubber blade 221′ of the front door window wiper 22′ over the part 41 of the front door window 4 alternatively forwards and backwards.

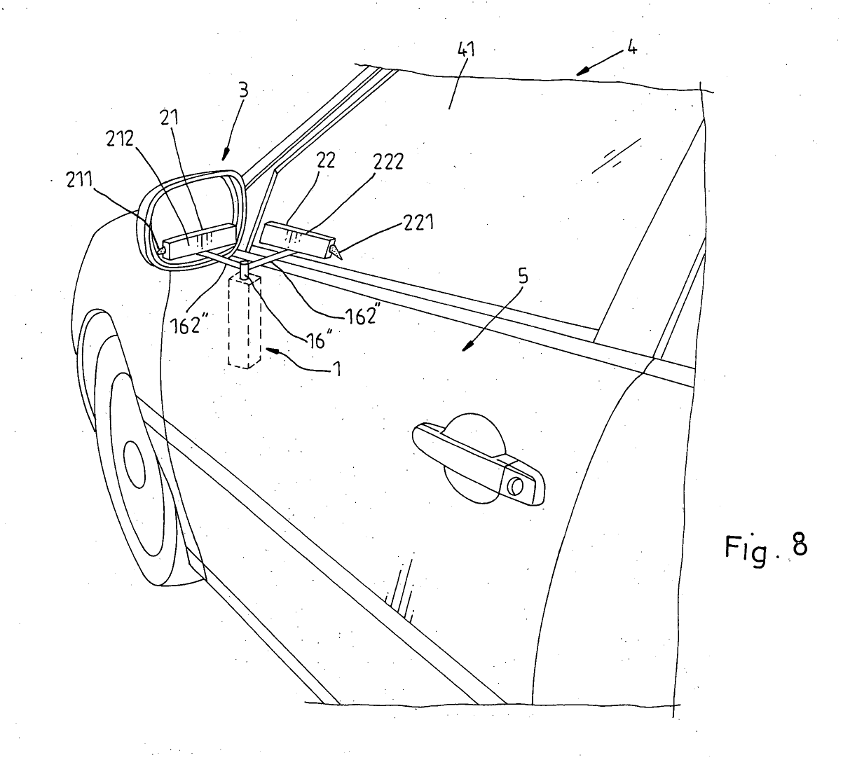

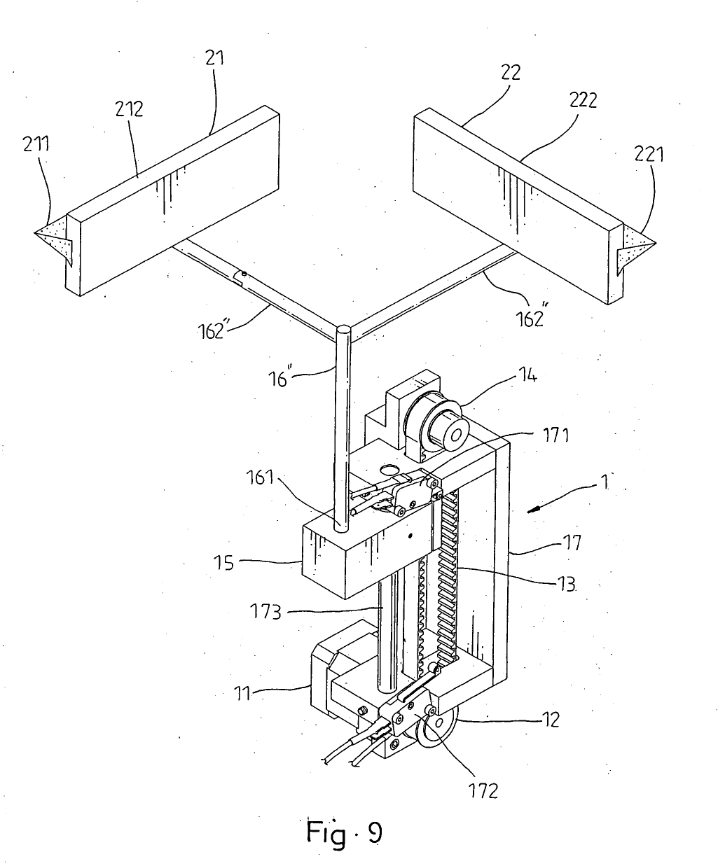

FIGS. 8 and 9 show still another alternate form of the present invention. According to this embodiment, the combination wiper is comprised of one transmission unit 1, an outside mirror wiper 21, and a front door window wiper 22. The transmission unit 1 is substantially similar to the transmission units of the aforesaid various embodiments of the present invention with the exception of the connection rod 16″. The connection rod 16″ has one first end 161 fixedly connected to the slide 15, and two second ends 162″ arranged at right angles and respectively connected to the handle 212 of the outside mirror wiper 21 and the handle 222 of the front door window wiper 22.

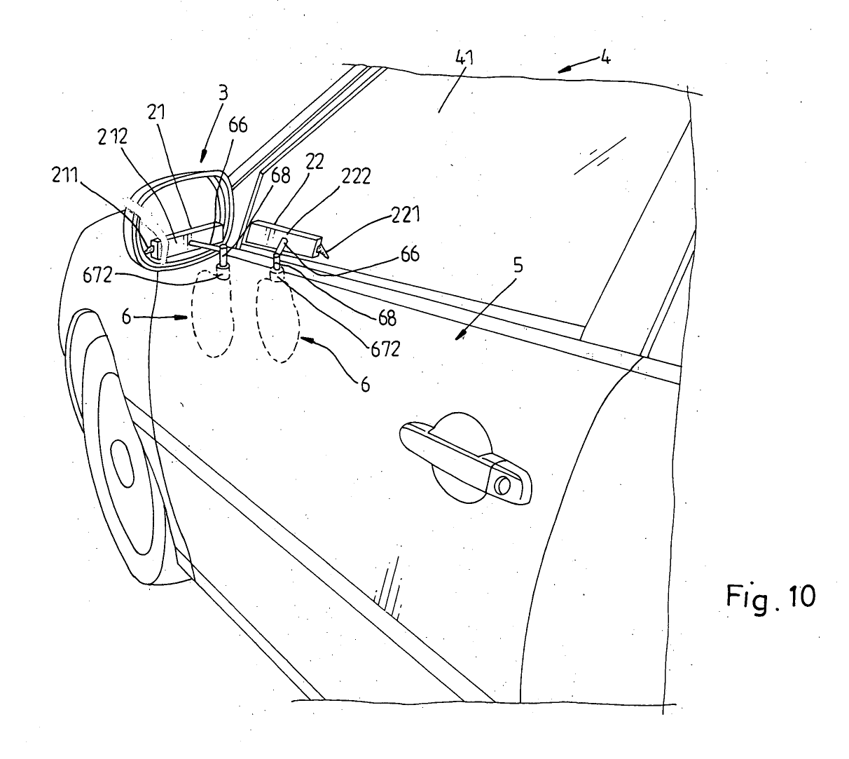

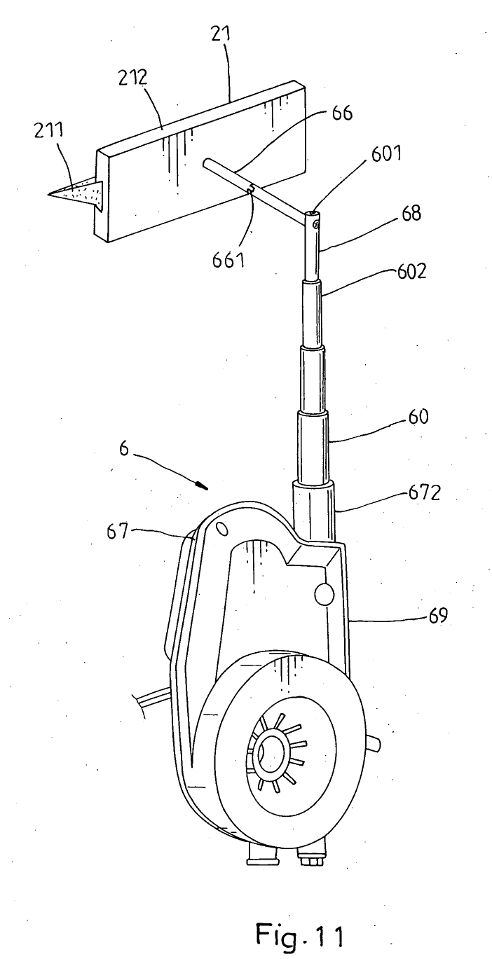

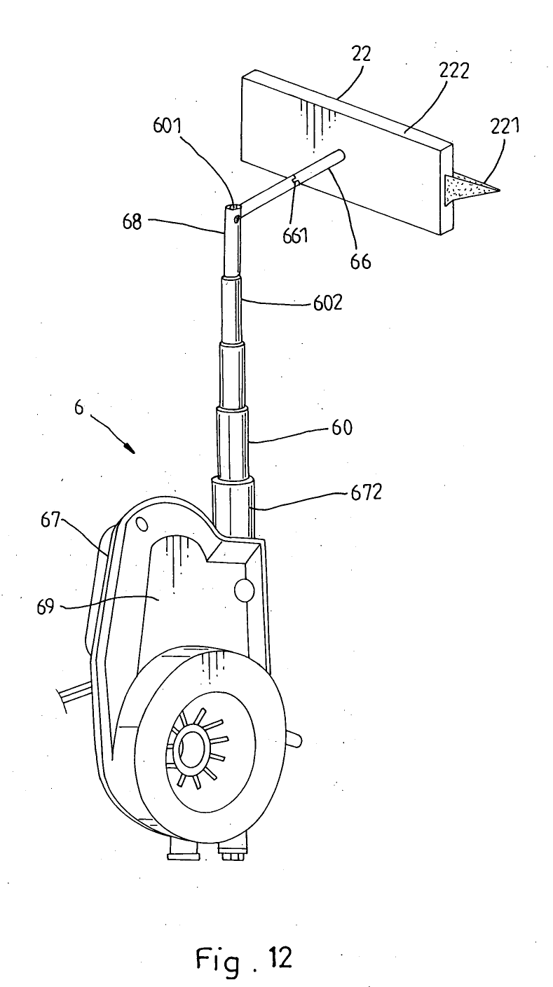

FIGS. 10˜13 show still another alternate form of the present invention. According to this embodiment, each transmission unit 6 is comprised of a motor 61, a worm 62, a worm gear 63, a flexible plastic rack 64, a bobbin 65, a telescopic tube 60, a holder frame 67, a cover 69, a connection rod 66, and an ornamental tube 68. The motor 61 is controlled to drive the worm 62 to rotate the worm gear 63. The worm gear 63 has a toothed portion 631 meshed with the flexible plastic rack 64. The flexible plastic rack 64 is extending over the periphery of the bobbin 65, having one end meshed with the toothed portion 631 of the worm gear 63 and the other end inserted through a barrel 672 at the holder frame 67 into the inside of the telescopic tube 60 and fixedly connected to the top second section 602 of the telescopic tube 60. Therefore, when the motor 61 is rotated clockwise and counter-clockwise alternatively, the worm 62 is driven to rotate the worm gear 63 clockwise and counter-clockwise alternatively, thereby causing the worm gear 63 to reciprocate the flexible plastic rack 64, and therefore the telescopic tube 60 is moved between the extended position and the received position alternatively. The first top section 601 of the telescopic tube 60 is covered with the ornamental tube 68 and connected to one end of the connection rod 66. The other end of the connection rod 66 is connected to the handle 212 or 222 of the outside mirror wiper 21 (see FIG. 11) or front door window wiper 22 (see FIG. 12). Further, two sensors 673 and 674 are installed in the holder frame 67 at suitable locations. The flexible plastic rack 64 has a detective portion 641 to be detected by the sensors 673 and 673 to control clockwise/counter-clockwise rotation of the motor 61. Further, the connection rod 66 has two parts pivotally connected together with a pivot 661.

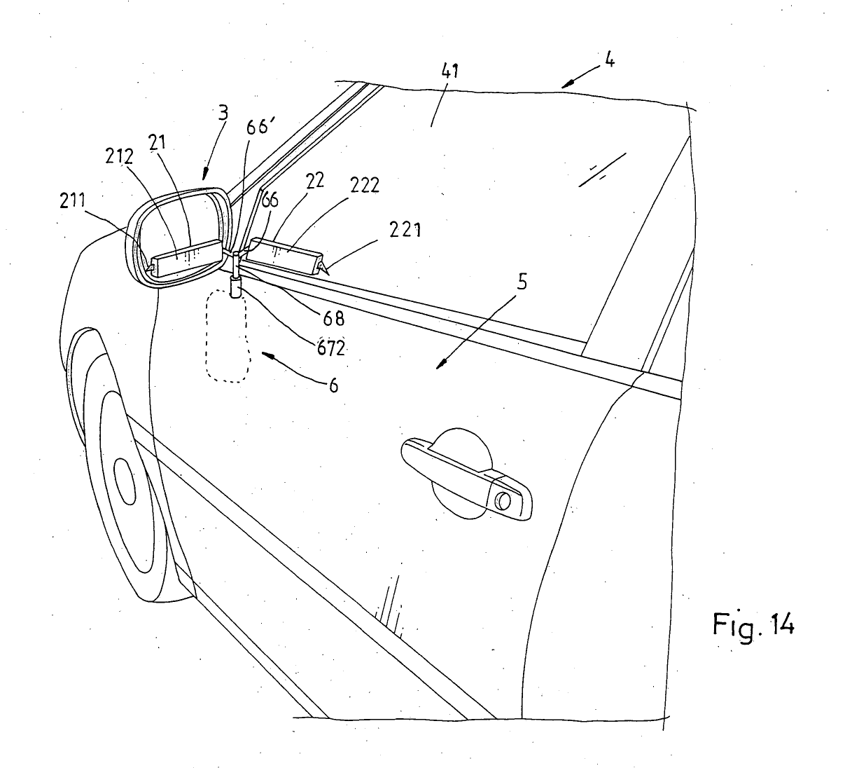

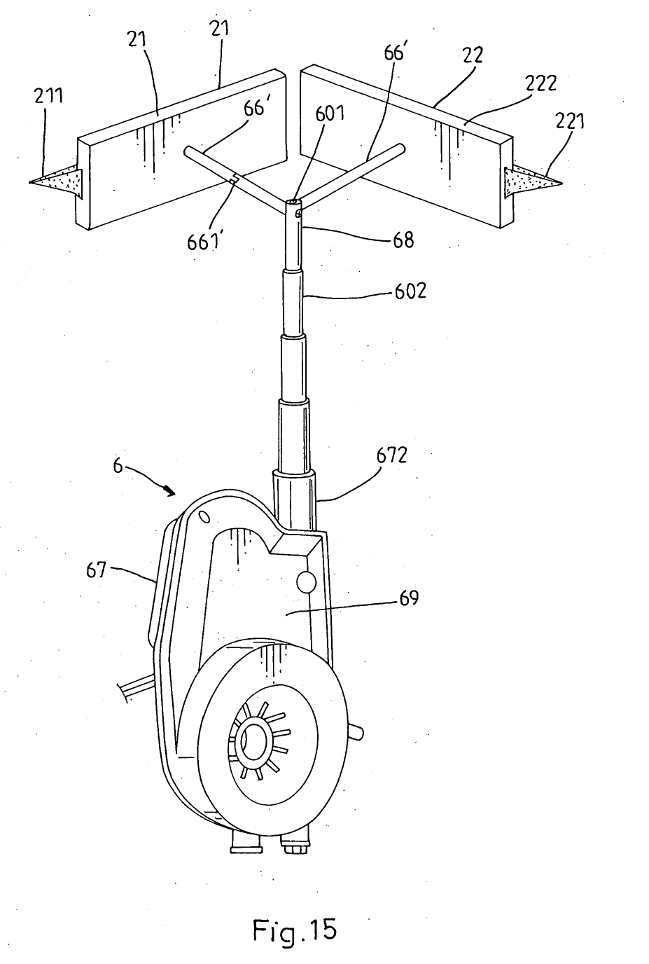

FIGS. 14 and 15 show still another alternate form of the present invention. According to this embodiment, the combination wiper comprises only one transmission unit 6. The transmission unit 6 is same as the embodiment shown in FIGS. 11˜13. Further, two connection rods 66′ are respectively connected to the first top section 601 of the telescopic tube 60 at different angles to secure the outside mirror wiper 21 and the front door window wiper 22 to the telescopic tube 60. Further, the connection rod 66′ that is connected to the outside mirror wiper 21 has two parts pivotally connected together with a pivot 661′.

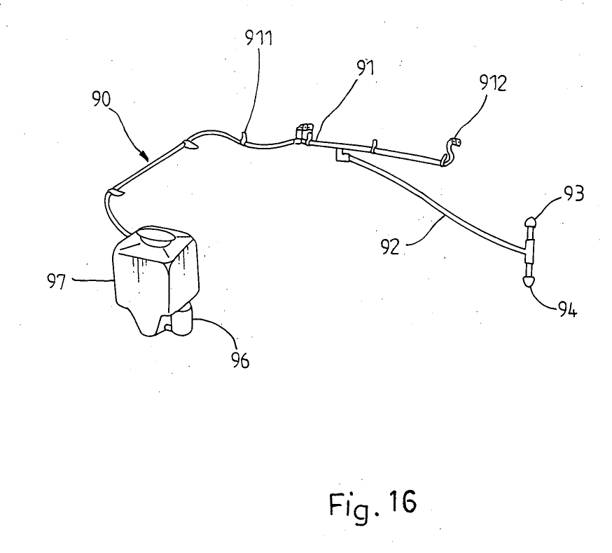

Referring to FIG. 16, two spray nozzles 93 and 94 may be connected to the water supply tube 91 of the water sprayer 90 of the car through a branch tube 92 for spraying water over the lens of the outside mirror 3 and the part 41 of the front door window 4 (see also FIG. 1). The water sprayer 90 comprises a motor pump 96, a water tank 97. The water supply tube 91 is connected to the water tank 97, having two jet nozzles 911, 912 arranged at the bottom side of the windshield of the car.

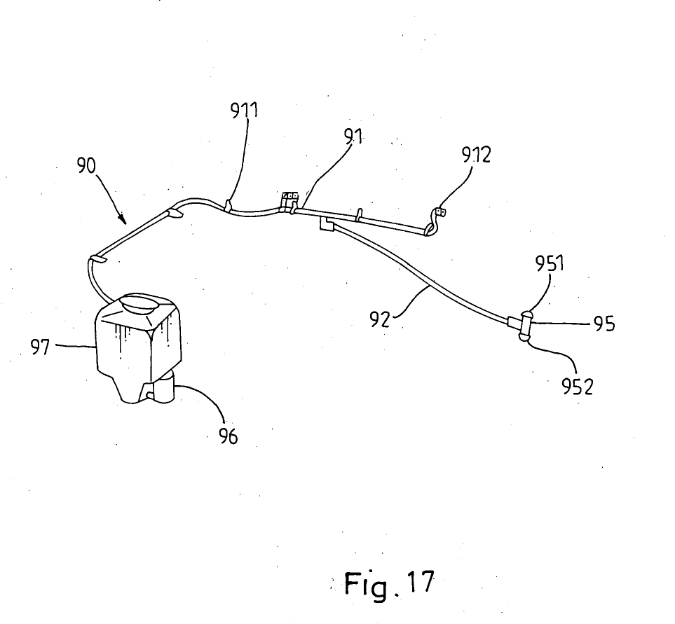

Referring to FIG. 17, one spray nozzle 95 having two nozzle holes 951 and 952 may be used and connected to the water supply tube 91 of the water sprayer 90 of the car through the branch tube 92 to substitute for the two spray nozzles 93 and 94 shown in FIG. 16 for spraying water over the lens of the outside mirror 3 and the part 41 of the front door window 4 (see also FIG. 1).

Further, the combination wiper may be electrically connected to the control circuit of the car that controls the operation of the windshield wipers so that the driver can control the operation of the windshield wipers and the combination wiper conveniently through the control circuit of the car.

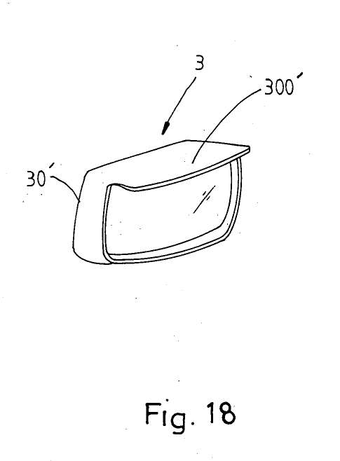

Referring to FIG. 18, the housing 30′ of the outside mirror 3 has a brim 300′ for protection against rainwater and sunlight.

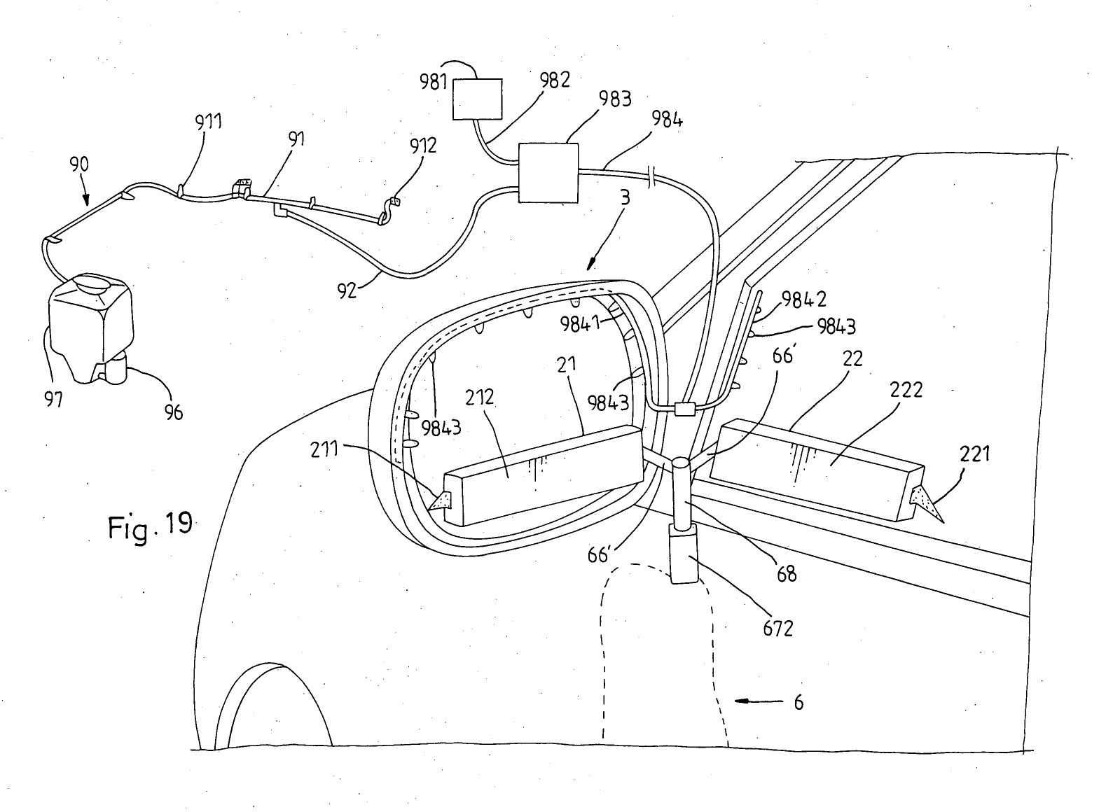

Referring to FIG. 19, an air pump 981 is provided and connected a selector switch 983 through an air tube 982. A branch tube 92 is connected between the water supply tube 91 of the water sprayer 90 of the car and the selector switch 983. The selector switch 983 is further connected to a water/air supply tube 984. Two branch tubes 9841 and 9842 are respectively extended from the remote end of the water/air supply tube 984 and closely attached to the outside mirror 3 and the front door window 4. The branch tubes 9841 and 9842 each have a plurality of jet nozzles 9843 for output of water or air. By means of operating the selector switch 983, the driver can select to have water or air be applied to the outside mirror 3 and the front door window 4. The water sprayer 90 comprises a motor pump 96, a water tank 97. The water supply tube 91 is connected to the water tank 97, having two jet nozzles 912 arranged at the bottom side of the windshield of the car.

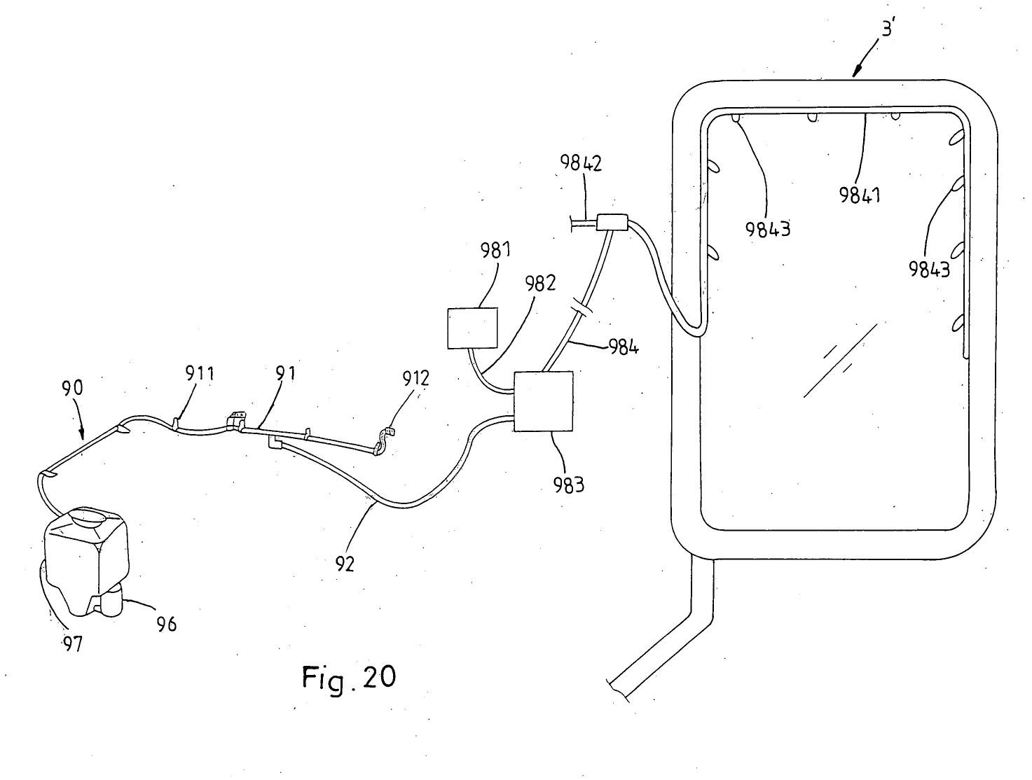

FIG. 20 shows still another alternate form of the present invention. This embodiment is substantially similar to the embodiment shown in FIG. 19 with the exception of the design of the outside mirror 3′.

As indicated above, the combination wiper uses one or two transmission units to bias two wipers, thereby removing raindrops, dust, sands, etc. from the outside mirror and a specific part of the front door window of the car.

Although particular embodiments of the invention have been described in detail for purposes of illustration, various modifications and enhancements may be made without departing from the spirit and scope of the invention. Accordingly, the invention is not to be limited except as by the appended claims

What is claimed is:

1. A combination wiper installed in a car and adapted to clean the lens one outside mirror and one front door window of the car, the combination wiper comprising:
a first wiper adapted to clean the lens of the outside mirror, said first wiper comprising a handle and a rubber blade fixedly fastened to the handle and attached to the lens of the outside mirror;
a second wiper adapted to clean a predetermined part of the front door window, said second wiper comprising a handle and a rubber blade fixedly fastened to the handle and attached to the predetermined part of the front door window; and
a transmission system adapted to drive the handle of said first wiper and the handle of said second wiper to move the associating rubber blades alternatively back and forth over the lens of the outside mirror and the predetermined part of the front door window.

2. The combination wiper as claimed in claim 1, wherein said transmission system comprises two transmission units and two connection rods respectively connected between said transmission units and the handles of said first wiper and said second wiper, said transmission unit each comprising a holder frame, a reversible motor fixedly mounted in said holder frame, a transmission wheel pivotally mounted in said holder frame rotatably by said reversible motor, a driven wheel pivotally mounted in said holder frame, a transmission belt mounted on said transmission wheel and said driven wheel, a guide rod fixedly mounted inside said holder frame, and a slide fixedly connected to one end of the associating connection rod and coupled to said guide rod and movable by said transmission belt along said guide rod.

3. The combination wiper as claimed in claim 2, wherein the connection rod that is connected to the handle of said first wiper has two parts pivotally connected together with a pivot.

4. The combination wiper as claimed in claim 2, wherein the transmission unit that controls said first wiper is installed inside the outside mirror, and the connection rod that connects said first wiper to the associating transmission unit extends out of the outside mirror through an opening in the outside mirror to hold said first wiper on the lens of the outside mirror.

5. The combination wiper as claimed in claim 1, wherein said transmission system comprises a transmission unit and a connection rod, said connection rod having a first end connected to said transmission unit, a second end connected to the handle of said first wiper, and a third end connected to the handle of said second wiper, said transmission unit comprising a holder frame, a reversible motor fixedly mounted in said holder frame, a transmission wheel pivotally mounted in said holder frame rotatably by said reversible motor, a driven wheel pivotally mounted in said holder frame, a transmission belt mounted on said transmission wheel and said driven wheel, a guide rod fixedly mounted inside said holder frame, and a slide fixedly connected to the first end of said connection rod and coupled to said guide rod and movable by said transmission belt along said guide rod.

6. The combination wiper as claimed in claim 1, wherein said transmission system comprises two transmission units and two connection rods respectively connected between said transmission units and the handles of said first wiper and said second wiper, said transmission units each comprising a holder frame, a reversible motor fixedly mounted in said holder frame, a worm pivotally mounted in said holder frame rotatably by said reversible motor, a worm gear pivotally mounted in said holder frame and meshed with said worm, a bobbin pivotally mounted in said holder frame, a telescopic tube, said telescopic tube having a fixed rear end fixedly connected to said holder frame and a movable front end connected to the associating connection rod, and a flexible plastic rack mounted on said bobbin and meshed with said worm gear, said flexible plastic rack having one end inserted into the inside of said telescopic tube and connected to the movable front end.

7. The combination wiper as claimed in claim 1, wherein said transmission system comprises a transmission unit and a connection rod, said connection rod having a first end connected to said transmission unit, a second end connected to the handle of said first wiper, and a third end connected to the handle of said second wiper, said transmission unit comprising a holder frame, a reversible motor fixedly mounted in said holder frame, a worm pivotally mounted in said holder frame rotatably by said reversible motor, a worm gear pivotally mounted in said holder frame and meshed with said worm, a bobbin pivotally mounted in said holder frame, a telescopic tube, said telescopic tube having a fixed rear end fixedly connected to said holder frame and a movable front end connected to the first end of said connection rod, and a flexible plastic rack mounted on said bobbin and meshed with said worm gear, said flexible plastic rack having one end inserted into the inside of said telescopic tube and connected to the movable front end.

8. The combination wiper as claimed in claim 1, further comprising a water sprayer, two spray nozzles respectively connected to said water sprayer through a water tube and respectively aimed at the lens of the outside mirror and the predetermined part of the front door window and controllable by said water sprayer to spray water over the lens of the outside mirror and the predetermined part of the front door window.

9. The combination wiper as claimed in claim 1, further comprising a spray nozzle connected to a water sprayer of the car through a water tube, said spray nozzle having two nozzle holes respectively aimed at the lens of the outside mirror and the predetermined part of the front door window.

10. The combination wiper as claimed in claim 1, further comprising a water sprayer, an air pump, two spray nozzles respectively aimed at the lens of the outside mirror and the predetermined part of the front door window, a water tube, which connects said spray nozzles to said water sprayer, an air tube, which connects said spray nozzles to said air pump, and a selector switch installed in said water tube and said air tube and adapted to selectively turned on/off said water tube and said air tube.
